(19) United States
(12) Patent Application Publication
(10) Pub. No.: US 2022/0327610 A1
(43) Pub. Date: Oct. 13, 2022

(54) EXTENDING RENTAL PERIODS BASED UPON THE PROBABILITY OF AN OCCURRENCE OF OBSERVED WEATHER CONDITIONS

(71) Applicant: 1848 Ventures, LLC, Westfield Center, OH (US)

(72) Inventors: Richard Conway Wilmot, Brunswick, OH (US); Christopher Paul McPherson, Akron, OH (US)

(73) Assignee: 1848 Ventures, LLC, Westfield Center, OH (US)

(21) Appl. No.: 17/717,925

(22) Filed: Apr. 11, 2022

Related U.S. Application Data
(60) Provisional application No. 63/173,337, filed on Apr. 9, 2021.

(51) Int. Cl. G06Q 30/06; G01W 1/10

(52) U.S. Cl. CPC G06Q 30/0645; G06Q 30/0611; G01W 1/10

(57) ABSTRACT

The present disclosure includes methods of providing an equipment use guarantee quotation. In certain embodiments, such methods include: obtaining equipment rental information; obtaining a covered weather condition parameter corresponding to a weather condition that may occur during the rental period or during a time period preceding a rental period at a rental use location, the covered weather condition parameter being a threshold amount of a weather condition that would trigger a use guarantee for the rental equipment item during the rental period; receiving predictive weather condition information corresponding to the weather condition that may occur during the rental period or during a time period preceding the rental period at the rental location; estimating a probability of an occurrence that the weather condition will result in meeting or exceeding the covered weather condition parameter during the rental period or during a time period preceding the rental period.

### CROSS-REFERENCE TO RELATED APPLICATIONS

This application claims priority to, and the benefit of, U.S. Provisional Patent Application No. 63/173,337, filed Apr. 9, 2021 with the U.S. Patent Office, the disclosure of which is hereby incorporated by reference.

### BACKGROUND

It is not uncommon for renters of equipment to be unable to use rental equipment due to the occurrence of one or more weather events. Weather events, as used herein, reflect the occurrence of certain weather that my cause a renter to be sufficiently unable to use or accomplish certain tasks with the rented equipment for any portion of a rental period. By example, and without limitation, weather events may include: the occurrence or an excessive amount of rain, snow, or other precipitation; excessive or sufficiently low air temperatures; and, excessive wind. Presently, it would be desirable for renters to obtain some form of protection against the occurrence of weather events, based upon the monitoring and identification of the occurrence of certain weather events. One particular problem is estimating (determining) the likelihood of an occurrence (probability) of a weather event, which may be any of a variety of weather events and which such estimations may regard any related parameter. Timely review and evaluation of current forecasts and even historical weather data poses a problem, in addition to the further complexity that arises in also reviewing and evaluating certain nuances of any particular parameter associated with a weather event can be problematic, especially when requiring a reasonably accurate estimate and determination regarding probability at the time a renter is securing an equipment rental, as this determination is required almost instantly.

### SUMMARY

The present disclosure includes methods of providing an equipment use guarantee quotation.

In certain embodiments, such methods include obtaining equipment rental information stored on a non-transitory computer readable medium, the equipment rental information comprising information concerning a rental equipment item for rental by a rental party from a rental provider for a rental period at a rental use location, the equipment rental information including rental period information corresponding with the rental period, rental equipment item information corresponding to the rental equipment item, rental price information corresponding to the rental price for the rental equipment item, and the rental use location information corresponding to the rental use location.

In certain embodiments, such methods may further include obtaining a covered weather condition parameter stored on a non-transitory computer readable medium, the covered weather condition parameter corresponding to a weather condition that may occur during the rental period or during a time period preceding the rental period at the rental use location, the covered weather condition parameter being a threshold amount of the weather condition that would trigger a use guarantee for the rental equipment item during the rental period or during a time period preceding the rental period.

In certain embodiments, such methods may further include receiving, via a network interface, predictive weather condition information corresponding to the weather condition that may occur during the rental period or during a time period preceding the rental period at the rental location.

Such methods, in certain embodiments, may further include estimating, by a processor of a computing device, a probability of an occurrence that the weather condition, as an observed weather condition, will result in meeting or exceeding the covered weather condition parameter during the rental period or during a time period preceding the rental period at the rental use location.

Such methods may further include, in certain embodiments, determining, based upon the probability, a price to charge the renter to provide the renter a rental period extension should the observed weather condition during the rental period or during a time period preceding the rental period meet or exceed the covered weather condition parameter.

Such methods may further include, in certain embodiments, monitoring, by a processor of a computing device, observed weather condition information corresponding to the observed weather condition at or near the rental use location during the rental period or during a time period preceding the rental period.

In certain embodiments, such methods may further include determining, by a processor of a computing device, if the observed weather condition meets or exceeds the covered weather condition parameter during the rental period or during a time period preceding the rental period at or near the rental use location.

Further embodiments of the disclosure include systems for performing such methods. In certain embodiments, the system includes one or more processors and one or more computer readable storage mediums in operable communication with the processor, where the one or more computer readable storage mediums including instructions for performing any of the methods described or contemplated above and elsewhere herein.

Further embodiments of the disclosure include computer program products, each of which include instructions embodied one or more computer readable storage mediums. The instructions form any steps of the methods described or contemplated above or elsewhere herein.

Further embodiments of the disclosure include any product, process, method, system, computer program, or other invention described in this disclosure.

Further embodiments of the disclosure comprise a method of determining the likelihood of an occurrence of a covered weather condition parameter associated with a particular weather event, the method comprising: obtaining equipment rental information stored on a non-transitory computer readable medium, the equipment rental information comprising information concerning a rental equipment item for rental by a rental party from a rental provider for a rental period at a rental use location, the equipment rental information including rental period information corresponding with the rental period, rental equipment item information corresponding to the rental equipment item, rental price information corresponding to the rental price for the rental equipment item, and the rental use location information corresponding to the rental use location; obtaining a covered weather condition parameter stored on a non-transitory computer readable medium, the covered weather condition parameter corresponding to a weather condition that may occur during the rental period or during a time period preceding the rental period at the rental use location, the covered weather condition parameter being a threshold amount of the weather condition that would trigger a use guarantee for the rental equipment item during the rental period or during a time period preceding the rental period; receiving, via a network interface, predictive weather condition information corresponding to the weather condition that may occur during the rental period or during a time period preceding the rental period at the rental location; and, estimating, by a processor of a computing device, a probability of an occurrence that the weather condition, as an observed weather condition, will result in meeting or exceeding the covered weather event parameter during the rental period or during a time period preceding the rental period at the rental use location.

As part of any method contemplated herein, or as a standalone method, the method may include training a predictive machine learning model or algorithm (artificial intelligence) using data, such as one or more datasets or databases including historical weather data, forecasted weather data, observed weather data, and/or predictive weather information. The predictive machine learning model or algorithm may concern the prediction or estimation of a covered weather condition parameter. Machine learning and the training thereof may be performed on any one or more processors described herein.

### BRIEF DESCRIPTION OF THE DRAWINGS

The foregoing and other objects, features, and advantages will be apparent from the following more detailed descriptions of particular embodiments, as illustrated or exemplified in the accompanying drawings wherein like reference numbers, symbols, or the like represent like parts, features, or characteristics of particular embodiments:

FIG. 1 is a flow chart showing a process for evaluating weather risk for a rental period and determining a price and quotation based thereon for guaranteeing use of rental equipment for the rental period based upon the occurrence of a weather event or weather condition, in accordance with an exemplary embodiment;

FIG. 2 is a flow chart showing a process for evaluating weather risk for a rental period and determining a price and quotation based thereon for guaranteeing use of rental equipment for the rental period based upon the occurrence of a weather event or weather condition, in accordance with another exemplary embodiment;

FIG. 3 is a flow chart for determining a probability that a covered weather condition would occur based upon a current weather forecast and a predicted uncertainty in the forecast;

FIG. 4 is a flow chart for monitoring the weather during a rental period;

FIG. 5 is a chart showing a weather forecast with risks associated with each daily weather forecast based upon the methods discussed herein;

FIG. 6 is a table showing risks and probability rates with associated pricing for a use guarantee policy;

FIG. 7 is a schematic of a system for performing the methods described and contemplated herein; and,

FIG. 8 is a chart showing a kernel density estimation distribution of predicted amount of rainfall over the span of a rental period.

### DETAILED DESCRIPTION

The methods and software products described herein are intended to protect construction subcontractors in the case rental equipment becomes unusable due to the occurrence of certain weather events or weather conditions that may arise during a rental period. This protection (also referred to as a “use guarantee”) may take any form, such as the form of a guarantee or an insurance policy, and may be offered and sold directly to a renter in conjunction with a rental agreement for the equipment by the renter or by a third party, as an add-on thereto or separately as an independent agreement. The guarantee or policy, or more generally “protection” or “use guarantee,” may be provided by rental providers or by an independent party separate from a rental provider. Any reference to any particular protection or use guarantee herein, is applicable to, and may be substituted with, any other form of protection unless otherwise noted. For example, any reference to a guarantee may be applicable to, and may be substituted with, an insurance policy.

One benefit of these methods and products, in accordance with particular embodiments, is that an extension to the rental period may occur automatically, based upon the monitoring and communication methods described and contemplated herein, without reporting the occurrence of any weather event or condition.

Another benefit of these methods and products, in accordance with particular embodiments, is generating a more accurate forecasted weather probability using historical data in combination with prior forecasts to determine the reliability or uncertainty in a current forecast. Such benefits may also be obtained more quickly and timely.

Yet another benefit of these methods and products, in accordance with particular embodiments, is generating a more accurate probability regarding the likely occurrence of a weather event or weather condition during a rental period using historical data. Such benefits may also be obtained more quickly and timely.

“Rental equipment item,” as used herein, comprises any equipment that may be rented, such as for home, commercial, or industrial building construction or landscaping purposes, which may include, for example, cranes, backhoes, excavators, lifts (e.g., vertical lifts, scissor lifts, boom lifts, and forklifts), skid steers, track loaders, air compressors, generators, portable lights, and hand tools.

“Rent,” “rental,” or “renting,” as used herein, refers to the act of providing payment of money or other compensation for the right to temporarily use something, such as a rental equipment item.

“Rental party” or “renter,” as used herein, refers to a party providing payment for the temporary right to use something in the act of renting. A rental party or renter, as used herein, may be any person or business entity, and a renter, as used herein, includes a potential renter, one that is in the process of becoming a renter, or an actual renter, unless otherwise provided.

“Rental provider” or “rental source,” as used herein, refers to a party that provides something to be temporarily used by a renter in the act of renting.

“Rental period,” as used herein, refers to an original period of rental between a renter and a rental provider. This rental period may comprise any range of time, which may be expressed in hours, days, or weeks, for example. The rental period may be extended as contemplated herein.

“Rental use location,” as used herein, refers generally to the location where the rental equipment will be used by the renter (e.g., the jobsite). It is contemplated that there may be one or more rental locations for any given rental of equipment for a rental period. The rental use location may be precise or more general. For example, rental use location may comprise geographical position coordinates, such as latitude and longitude or as otherwise may be employed by or obtained from any global positioning system (GPS) or the like. By further example, rental use location may comprise a geographical location identifier, such as a street address, zip code, or city or township name. It is contemplated that any other known or discovered geographical indicators may be used to identify a rental use location.

The present invention includes systems, devices, methods, and computer program products. The systems or devices product may include computer readable storage mediums having computer readable program instructions thereon for causing a processor to carry out aspects of the present invention.

A computing system or device comprises a processor and a non-transitory computer readable medium. The non-transitory computer readable medium may comprise any type of memory and/or storage, and may include computer readable program instructions thereon for causing a processor to carry out aspects of the present invention. A computing system or device may further include an input device, such as any form of a mouse, controller, keyboard, touch screen, keypad, or voice input device, and/or an output device, such as a graphical user interface, display device, printer, or speaker. By way of example, a computing system or device may comprise a portable computing unit, laptop computer, mobile device, mobile phone, smartphone, navigation device, tablet personal computer, personal digital assistant (PDA), desktop computer system, workstation, internet appliance, server, or web server. Any such device may be configured to connect with any network, such as by wired or wireless connection, thereby providing the capability of communicating with other computing devices.

A computer readable storage medium comprises any tangible device that can retain and store information, data, and/or instructions for use by an instruction execution device or processor. The computer readable storage medium may be, for example, an electronic storage device, a magnetic storage device, an optical storage device, an electromagnetic storage device, a semiconductor storage device, or any suitable combination thereof. More specific examples of the computer readable storage medium include: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination thereof. A computer readable storage medium, as used herein, may include non-transitory computer readable storage medium, that is, that which does not include transitory signals per se. A computer readable storage medium can reside in any of a variety of locations, such as local to (and/or resident in) one or more computing devices or remote from any or all of the computing devices across the network.

A network, as used herein, may comprise any network where information or data may be communicated, such as by wire or wireless transmission, for example. For example, a network comprise a local area network, a wide area network, a wireless wide area network, a circuit-switched telephone network, a Global System for Mobile Communications (GSM) network, Global Positioning System (GPS) network, a Wireless Application Protocol (WAP) network, a WiFi network, an IEEE 802.11 standards network, various combinations thereof, etc. Any other networks may be employed, without departing from the scope of the present invention, such as may be known by one of ordinary skill in the art. The network may comprise any means for transmission, including without limitation, copper transmission cables, optical transmission fibers, wireless transmission, routers, firewalls, switches, gateway computers and/or edge servers. A network interface sends, receives, or otherwise transmits or communicates information, data, and/or computer readable program instructions to or from a network.

Computer readable program instructions described herein can be downloaded to respective computing devices from a computer readable storage medium or to an external computer or external storage device via a network.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions. The flowchart and block diagrams in the Figures illustrate the architecture, functionality, and operation of possible implementations of systems, methods and computer program products according to various embodiments of the present disclosure. In this regard, each block in the flowchart or block diagrams may, but not always, represent a module, segment, or portion of code, which comprises one or more executable instructions for implementing the specified logical function(s). It should also be noted that, in some alternative implementations, the functions noted in the block may occur out of the order noted in the figures.

One issue faced by renters is the unfortunate occurrence of sufficiently inclement weather or certain weather events that render the use of any rented equipment during a rental period impractical or implausible. Should this occur, the renter would be faced with risking the use of the equipment under those less than desirable situations, risking accidents, damage, or injury, or not using the rented equipment and instead having to rent the equipment for an additional period of time. To resolve this uncertainty and avoid having to pay in full for an additional rental period, the renter or a third party (as a “guaranteeing party” or “guarantor”) may agree, in exchange for a fee, to extend the rental period or otherwise provide an additional or subsequent rental period for a particular duration should certain weather conditions or weather events arise during the rental period. This is a benefit to the renter, especially if the fee is less than the price to rent the equipment for an additional rental period. Before deciding to extend this opportunity to the renter, the third party may first evaluate the possibility and likelihood as to whether the certain weather conditions or events may occur during the rental period, such as by determining the probability or estimation of the occurrence of particular weather conditions or events or meeting, reaching, or achieving a covered weather condition parameter.

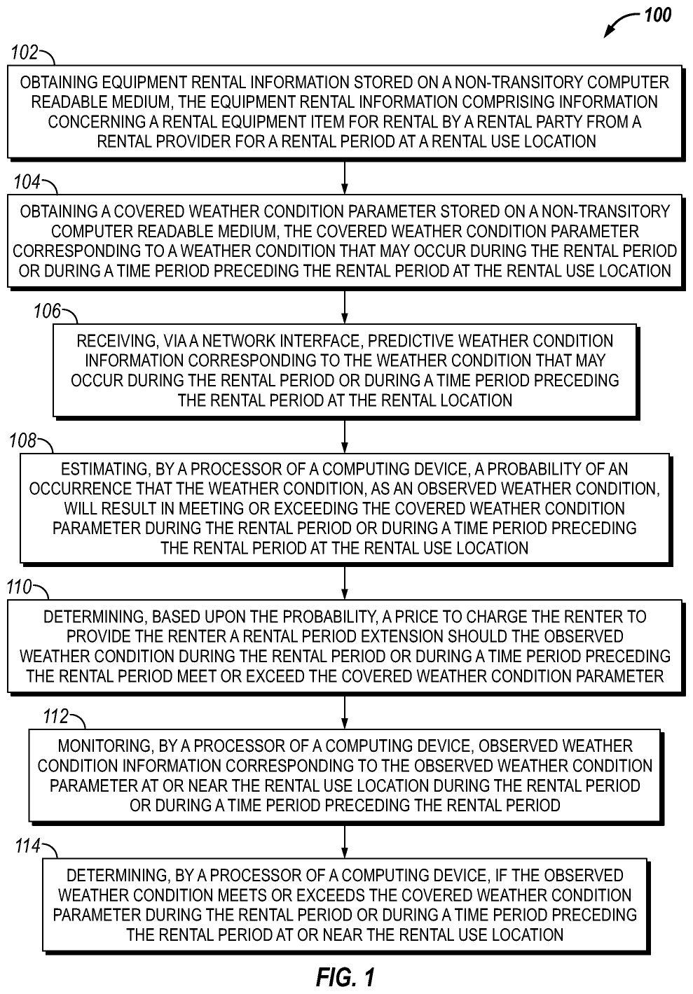

Particular embodiments of this disclosure comprise a method of providing a use guarantee to a renter of rental equipment, where such use guarantee provides an extended rental period or term of the rental equipment if the observed weather during the rental period or leading up to the rental period meets or exceeds a covered weather condition parameter, the covered weather condition parameter being a threshold measure of a weather condition or a weather event that may occur during the rental period, which includes the occurrence or non-occurrence of a weather condition or a weather event. Particular embodiments of this disclosure comprise a method of determining or estimating the occurrence of a weather condition or weather event or ultimately a covered weather condition parameter for any desired purpose, which may be, for example, for the purpose of providing a use guarantee to a renter of rental equipment, where such use guarantee provides an extended rental period or term of the rental equipment if the observed weather during the rental period or leading up to the rental period meets or exceeds a covered weather condition parameter, the covered weather condition parameter being a threshold measure of a weather condition or a weather event that may occur during the rental period. The following description shall be made with reference to exemplary embodiments described in FIGS. 1-8.

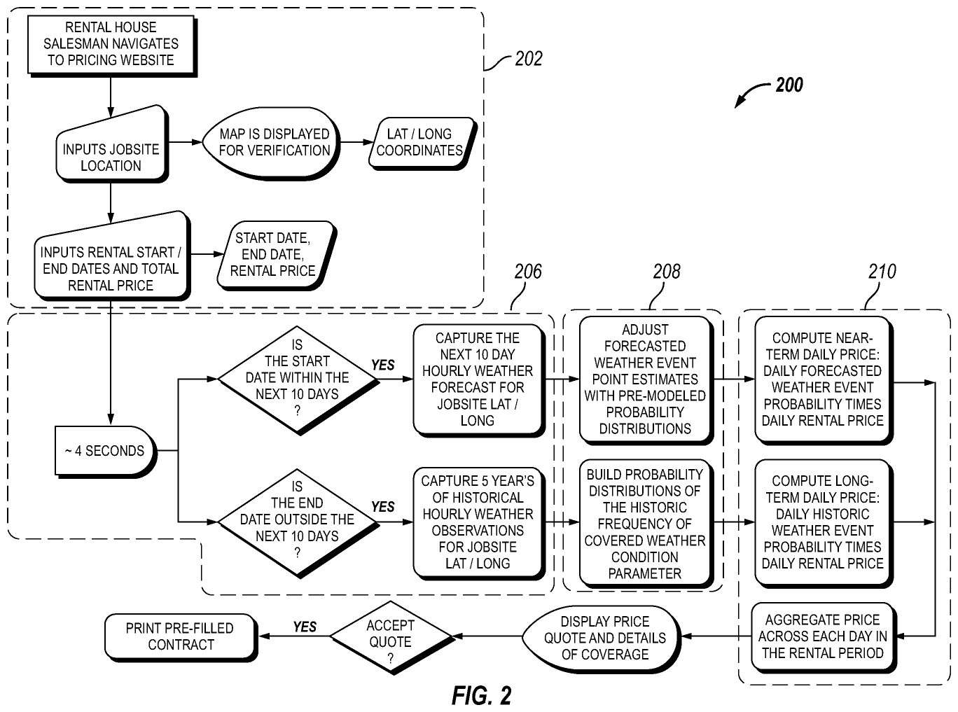

In particular embodiments, a method of providing an equipment rental use guarantee includes obtaining equipment rental information stored on a non-transitory computer readable medium. The equipment rental information comprises information concerning a rental equipment item for rental by a rental party from a rental provider for a rental period at a rental use location. The equipment rental information includes, without limitation: rental period information corresponding with the rental period (e.g., start date, end date, duration), rental equipment item information corresponding to the rental equipment item, rental price information corresponding to the rental price for the rental equipment item, and the rental use location information corresponding to the rental use location. This step is generally referred to as 102 in the method 100 shown in FIG. 1, according to a particular embodiment. In operation, a map may be displayed on a graphical user interface (GUI) for selection and/or verification, such as by a renter, for example. With reference to FIG. 2, in another exemplary method 200, an alternative step of obtaining rental equipment information is shown as 202.

Information is data of any form, including any form transmittable by way of a communication path and that which may be stored on a non-transitory computer readable storage medium (e.g., memory). Such information may be input by way of a computer system at the rental provider location, at the location of the party providing the use guarantee (the “guarantor”), or at any remote location by a renter or any other party. Likewise, such information may be stored on a non-transitory computer medium at the rental provider location, at the guarantor's location, the renter's location, or at any other remote location. This manner of storing information applies to the storage of all other types of information discussed or contemplated herein, unless otherwise specified. Data (information) may be stored and arranged in a database or take the form of datasets, any of which may also be employed to train machine learning models or algorithms.

Information (data) may be obtained by any known means, such as by electronic, digital, electromagnetic, analog, or optical transmission or signal. In one example, obtaining equipment rental information comprises receiving, via a network interface, equipment rental information from any source contemplated herein, including without limitation from the rental provider or any remote storage device employed by the rental provider. More broadly, information may be obtained through transmission by way of a communication path, which may be a wired or wireless transmission or signal. Information may be received from any source, including without limitation a computer readable storage medium, a sensor, or a global positioning system (GPS). This manner of obtaining all other types of information discussed or contemplated herein, unless otherwise specified.

Equipment rental information may include any information or details that may be provided by a rental provider or a renter concerning or related to a potential or current (existing) rental, such as may be reflected in a rental agreement, whether written or oral. For example, equipment rental information may include and without limitation: the rental period information, such as dates and times; the rental equipment item information concerning the equipment item to be rented (the “rental equipment item”); and, the rental price information for the rental equipment item, which may be expressed as a price per time period (such as price per hour, day, week, or month, for example). The equipment rental information may also include the hours of use (“work hours”) for each day of the rental period.

Information corresponding to the rental period is referred to as “rental period information,” which may include information corresponding to the dates of the rental period or a range of dates defining the rental period. Information corresponding to the rental equipment item is referred to as “rental equipment item information,” and may include information corresponding the type or category of the equipment as well as the make, model, and model year of the rental equipment.

Information corresponding to the rental price is referred to as the “rental price information.” The rental price for the rental equipment may be provided as a sum total for the rental period and/or in the form of a time basis rate, where the price is provided on the basis of a desired time period. For example, the rental price may be provided as an hourly rate (price per hour), a daily rate (price per day), a weekly rate (price per week), or a monthly rate (price per month). Because the pricing rate may change from hour-to-hour (hourly), day-to-day (daily), week-to-week (weekly), etc., the rental price may be conveyed in other forms to capture these nuances. Additional pricing information may be provided to capture other fees and taxes, as may be applicable. Additionally, rental prices for time bases arising subsequent to the rental period may be obtained to aid in the determination of pricing for guaranteeing use of the rental equipment item during the rental period.

At the time of renting equipment from a rental provider, a renter will provide to the rental provider certain information, such as renter name, renter contact information, and renter payment information. As a result of the rental, information will be available concerning the rental equipment (such as make, model, and category), the duration of the rental (the “rental period”), and the rental pricing. Any and all such information, including without limitation the information previously identified, is referred to herein as rental equipment information.

Rental equipment information may originate from the rental provider, the renter, or from a third party. For example, when creating a rental agreement between the rental provider and the renter, rental equipment information included in the agreement may be obtained from either party or from a third-party contract manager or the like. It is also possible certain information obtained from the agreement may be employed to located additional rental equipment information from other sources, such as from a source that is able to provide information concerning the equipment to be rented. Rental equipment information may be obtained by any known means, such as any means discussed or contemplated herein for obtaining information (data), and stored on a computer readable storage medium. If such information is received in a form not suitable for storage on a computer readable storage medium, such information may be entered manually entered and stored on a computer readable storage device.

An additional step of such methods may include obtaining a covered weather condition parameter stored on a non-transitory computer readable medium, the covered weather condition parameter corresponding to a weather condition that may occur during the rental period at the rental use location, the covered weather condition parameter being a threshold amount of the weather condition that would trigger a use guarantee for the rental equipment item during the rental period or during a time period preceding the rental period. This step is generally referred to as 104 in the exemplary method 100 shown in FIG. 1.

Weather conditions refer to characterizations or descriptors of the weather or the occurrence of a weather event. For example, weather conditions may include precipitation, such as rain, snow, or ice, air temperature, and wind speed. Weather conditions may include the occurrence of a tornado, hurricane, or other weather event. At the time of negotiating rental terms, agreeing to terms, or at a time thereafter, a renter may select, present, and/or confirm certain weather conditions for which the renter would like protection against, which are referred to as covered weather condition parameters. This is because the occurrence of certain weather conditions may render the use of rental equipment unreasonable, sufficiently difficult, impractical, or even virtually impossible. In operation, a covered weather condition parameter is any indicator of the occurrence of a weather event or of a threshold amount of the occurrence of a certain weather condition.

By way of example, if the weather condition is precipitation, the covered weather condition parameter may be a minimum threshold amount of precipitation within a particular time span, such as at least 4 inches in 2 hours. In another example, if the weather condition is wind, the covered weather condition parameter may be sustained winds of at least 25 miles per hour (mph). By further example, the covered weather condition parameter may be the occurrence of a tornado or a hurricane or the occurrence of a tornado, a tornado warning, or tornado watch. A covered weather condition parameter may be any weather condition and its measure or a weather event, as may be requested or desired by a renter or as may be offered to a renter.

For any covered weather condition parameter, such may further specify whether such parameter is to be met: (1) during the rental period at any time or within a certain amount of time after the rental period begins, which includes within a certain time period after a daily rental period begins; and/or, (2) within a certain period of time prior to a rental period or any portion of the rental period, such as within a certain time period before the start of a workday.

Obtaining protection for a covered weather condition parameter is a use guarantee, where should any one or more covered weather condition parameters be achieved, such as by a certain time on the day of coverage, the guarantor would provide an extra rental period. Any covered weather condition parameter that a renter may elect for coverage may be pre-defined and presented to the renter or the renter may request certain weather conditions parameters for coverage under a use guarantee.

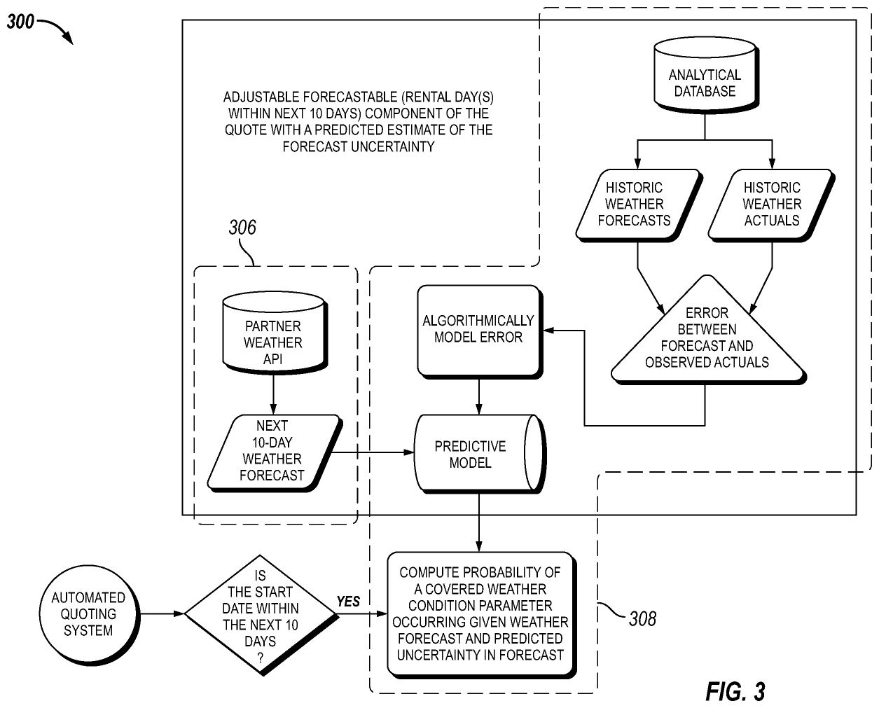

Embodiments of such methods further include receiving, via a network interface, predictive weather condition information corresponding to the weather condition that may occur during the rental period or during a time period preceding the rental period at the rental location. This step is generally referred to as 106 in the exemplary method 100 shown in FIG. 1. With reference to FIG. 2, in another exemplary method 200, an alternative step of receiving predictive weather information is shown as 206. With reference to FIG. 3, another exemplary method 300 is shown, with an alternative step of receiving predictive weather information shown as 306.

In an effort to determine how likely or unlikely the covered weather condition parameter may occur during any portion of a rental period, predictive weather condition information relating to the weather condition associated with the covered weather condition parameter is obtained that which relates to the rental period. In particular instances, predictive weather condition information relates to the covered weather condition information. It is appreciated that predictive weather condition information may be any information helpful to better understand what the weather conditions may likely be on during the rental period.

For example, this predictive weather condition information may comprise forecasted weather condition information obtained from weather forecasting sources. Additionally, or in the alternative, predictive weather condition information may be historical weather condition information obtained from any weather archival source, such as The Weather Company™, an IBM® business. Obtaining such information from a weather archival source, such as by way of an API (application programming interface), transfer, or download, for example, may occur at the time of evaluating such information, or such information may be obtained and stored on a memory device in advance, awaiting use and evaluation. This may be true for all other information useful in developing estimates and probabilities. Likewise, the estimates and probabilities contemplated herein may be prepared at the time a rental request is made, or such may be prepared in advance, so to be available at the time a rental request is made.

In particular instances, if the rental period is within a current upcoming forecast period, such as within a 10-day or 14-day forecast, the predictive weather condition information is the relevant portion of such upcoming forecast. If the rental period extends beyond an upcoming forecast period, the predictive weather condition information is historical weather condition information for the rental period and any time period leading up to or following the rental period. This is exemplary shown as 206 in accordance with an exemplary embodiment in FIG. 2.

It is appreciated that predictive weather condition information may be obtained not only for the rental period, or any portion thereof, but also for a period preceding and leading up to the rental period.

Predictive weather condition information is obtained in relation to the rental use location. In doing so, the predictive weather condition information may be obtained for the rental use location itself, for the municipality or township within which it is located, or for the surrounding area as may be defined within a particular radius otherwise.

Embodiments of such methods may include estimating or determining, by a processor of a computing device, a probability of an occurrence that the weather condition, as an observed weather condition, will result in meeting or exceeding the covered weather condition parameter during the rental period or during a time period preceding the rental period at the rental use location. This step is generally referred to as 108 in the exemplary method 100 shown in FIG. 1. With reference to FIG. 2, in another exemplary method 200, an alternative step of estimating is shown as 208. With reference to FIG. 3, yet another exemplary method 300 is shown, with an alternative step of estimating shown as 308. Such estimations or determinations as to probability may be obtained through use of a predictive model, and which may comprise a machine learning model or algorithm trained using corresponding data (information).

Depending on the probability as to the likelihood that any weather occurring during any portion of the rental period would result in any weather condition meeting or exceeding a covered weather condition parameter during the rental period, the price to charge a renter for a use guarantee for the rental equipment may vary. In particular, the higher the probability that a covered weather condition parameter may be attained (met or exceeded) during the rental period, the higher the price a renter will be charged for a use guarantee for the rental equipment. It is appreciated the probability may be determined in a variety of manners.

In certain instances, the probability of an occurrence that a weather condition, caused by the weather, will meet or exceed a covered weather condition parameter is obtained from a weather forecast, such as when the rental period, or a portion thereof, falls within a current weather forecast period. The weather forecast information may be obtained from any source, such as in the form of data, such as any non-transitory memory storage device through an application programming interface (API). Such forecasts may extend for any number of immediately future days, such as the immediate next 7 days, 10 days, or 14 days, for example. Forecasts may even extend a month or more into the future.

Weather forecasts, however, no matter how sophisticated, carry uncertainty and the weather that will come to pass will almost certainly deviate from the point estimates provided by the forecast. Accounting for this uncertainty enables one to generate price quotes for use guarantees that are more accurate and therefore fairer to renters, avoiding inaccurate and higher price quotes that may not properly relate to the uncertainty.

To accomplish this, the accuracy of historical forecasts is assessed, and the probability based upon a current forecast for the upcoming rental period is adjusted to take into account the inaccuracies associated with historical forecasts. Such determinations as to the accuracy regarding the probability may be obtained through use of a predictive model, and which may comprise a machine learning model or algorithm trained using corresponding data (information).

For example, historical forecasts and observed weather concerning the rental use location and/or any surrounding areas, such as the city or township, country, and/or state within which the rental use location resides or for the full United States, are obtained for analysis. This may occur on an as-need basis, such as when needed to determine a price quote for a use guarantee, or on a regular basis, whether periodically (e.g., daily or weekly) or continuously, to maintain a relatively current assessment as to the accuracy of weather forecasts. The observed and forecasted weather data is then compared to determine the amount of deviation between forecasted weather conditions and observed weather conditions. A probability distribution of the error is then obtained and predicted, such as by using machine learning algorithms or models. In other words, the probability a forecast will deviate and by how much is estimated. This, in effect, generates a measure of variability around the point estimates contained in a current forecast. This measure of variability permits greater precision in estimating the probability as to the occurrence of weather conditions that may meet or exceed the covered weather condition parameter. This process assessing historical forecasts and observed weather to develop more precise probability as to the occurrence of weather conditions that may meet or exceed the covered weather condition parameter results in an “enhanced probability.”

Temporally, the historical forecasts and observed weather assessed for accuracy may be assessed for any and all dates desired, or may be limited to historical weather forecasts for the rental period and/or for a period leading up to the rental period, such as any number of days or weeks leading up to the rental period. It is appreciated only the most recent historical forecasts and observed weather may be assessed that is within any desired last number of days, weeks, months, or years leading up to the rental period, or such most recent historical forecasts and observed weather may be weighed (weighted) more heavily than older historical forecasts and observed weather to arrive at an enhanced probability. It is appreciated that other information may be more heavily weighted than other information in developing more precise estimates or enhanced probability, for any covered weather condition parameter.

If the rental period is beyond any current weather forecast information, and therefore is not attainable, historical observed weather information (data) may be employed to determine the probable weather for the rental period and the probability as to the occurrence of weather conditions that may meet or exceed the covered weather condition parameter. Such determinations regarding probability may be obtained through use of a predictive model, and which may comprise a machine learning model or algorithm trained using corresponding data (information). The historical observed weather information may be obtained for any historical annual period, whether it's for the last 1 or 2 years or for the last 5, 10, or 20 years, for example. Optionally, in addition to employing the historical weather information for the rental period, historical observed weather information may be obtained for any desired period leading up to or following the rental period to further aid in determining the probable weather for the rental period and the probability as to the occurrence of weather conditions that may meet or exceed the covered weather condition parameter. As with the rental period previously discussed, the historical observed weather information for any period of time leading up to the rental period may be obtained for any historical annual period, whether it's for the last 1 or 2 years or for the last 5, 10, or 20 years, for example. It is appreciated only the most recent historical forecasts and observed weather may be assessed that is within any desired last number of days, weeks, months, or years leading up to the rental period, or such most recent historical forecasts and observed weather may be weighed (weighted) more heavily than older historical forecasts and observed weather to arrive at an enhanced probability. It is appreciated that other information may be more heavily weighted than other information in developing more precise estimates or enhanced probability, for any covered weather condition parameter.

In estimating or determining the probability, one may employ any desired probability or estimation technique, which may form the basis for any predictive model or algorithm, which includes any machine learning model or algorithm, which may be trained using corresponding data (information). In particular instances, probability density estimation techniques are employed, which includes without limitation preparation and use of regression techniques, histograms, parametric probability density estimation, and nonparametric probability density estimation. Particular embodiments employing nonparametric probability density estimation use kernel density estimation. Probability density functions determine a density of a density of a random variable, such as a variable associated with a desired weather condition, such as the observed weather data for the desired weather condition or a covered weather condition parameter for the desired weather condition or a binary (Boolean) determination as to whether a covered weather condition parameter based upon observed weather conditions was met over the course of a historic period of time associated with the rental period. Any functions may be employed, including Gaussian, Epanechnikov, Quartic, and uniform, to perform the probability estimation. In lieu of kernel density estimation, Gaussian or other desired estimators may be employed.

Without discussing all estimation techniques, by example, we discuss kernel density estimation, which is a non-parametric method for estimating the probability density function of a random variable. Kernel density estimation can be used for smoothing data (such as may be present in a histogram), where inferences about the population are made, based on a finite data sample. For example, let (x1, x2, . . . , xn) be an independent and identically distributed sample drawn from some distribution with an unknown density f. Estimating the shape of this function ƒ can comprise:

$${\hat{f}}_{h} ( x ) = \frac{1}{n} {\sum }_{i = 1}^{n} {K}_{h} ( x - {x}_{i} ) = \frac{1}{n h} {\sum }_{i = 1}^{n} K ( \frac{x - {x}_{i}}{h} ) , \qquad Eqn . ( 1 )$$

where K(⋅) is the kernel, a non-negative function that integrates to one and has mean zero, and h>0 is a smoothing parameter called the bandwidth. A kernel with subscript h is called the scaled kernel and defined as Kh(x)=1/h K(x/h). Therefore, h can be chosen as small as the data will allow, however there can be a trade-off between the bias of the estimator and its variance. A variety of kernel functions can be used: uniform, triangular, biweight, triweight, Epanechnikov, normal, etc.

In certain exemplary instances, the probability estimation technique includes obtaining desired historical weather condition information associated with a covered weather condition parameter for a desired period associated with the rental period. For the historical data obtained, for each day or other desired time period it is determined by what amount or to what extent the weather condition existed for desired time period, and using these determinations, determine a probability density estimate as to what amount or to what extent of the weather condition would be based upon the historical information.

In certain other exemplary instances, the probability estimation technique includes obtaining desired historical data associated with a covered weather condition parameter for a desired period associated with the rental period. For the historical data obtained, for each day or other desired time period there is a binary determination as to whether the covered weather condition parameter would have been met or not, and using the binary determinations, determine a probability density estimate as to whether the covered weather condition parameter would be met based upon the historical information.

Probability density estimation can be applied to the historical data, and based upon the estimations, determine the most likely point in the coverage area based on the historical observed weather data. For instance, the most frequently observed weather conditions can then be determined by finding the most likely point(s) on the density surface (e.g., kernel density surface) where the covered weather condition parameter was or would have been met. Once computed, the point(s) can be stored in a data structure indexed by a sector identifier, which can allow for efficient lookups to support both batch and real-time usage. The data structure can be updated at regular intervals (i.e., weekly, daily, hourly, etc.), by using the historical and most recently collected observed weather data.

In one example, when any portions of the proposed rental period are outside the upcoming 10-day forecast, 5 years of historic weather observations are obtained for the rental use location (either at the geographical location itself, at the nearest location or one of the nearest locations available). The data is filtered to include only the months represented in the proposed rental period. This filtered data set is then transformed into boolean (true/false) values that represent historic observed weather conditions that met (true) or did not meet (false) the covered weather condition parameter (e.g., daily precipitation greater than 0.5 inches). Kernel density estimation is applied to the transformed data to estimate the probability distribution for all of the combined covered weather condition parameters. Random samples are drawn against the estimated probability distribution and the mean of all samples is taken to represent the probability of a covered weather condition parameter being met.

In particular embodiments, probability may be parsed into different tiered ranges of probability, where the tiers extend from lower to greater probabilities. For example, one may provide four (4) probability tiers associated with a weather condition and the probability (risk) that it will occur on a given day, the 4 tiers being low, medium, high, and very high. See, for example, the weather risks (probabilities) shown in FIG. 5 is association with an exemplary forecast.

It is also appreciated that the probability for a rental period may be determined using any combination of techniques described or contemplated herein. In one example, a rental period contains ten (10) covered days and the quote request is made on March 22^{nd} for a rental period of March 29-April 9 (with workdays comprising Monday-Friday for each week). The first five (5) days are within a fourteen (14) day weather forecast. Therefore, the quotation or pricing of the rental period comprises a forecast portion for March 29-April 2 (5 days), which can utilize the existing 14-day forecast, and a historic portion comprising April 5-April 9 (5 days), which can utilize historical weather data.

In one example when utilizing weather forecasts, weather forecasts are obtained for the rental use location (the jobsite) each day of the forecast portion of the rental period from IBM® via IBM's probabilistic API (application program interface). Of course, any source of forecast information may be used, including any desired API. This API call includes the coverage threshold for each covered weather condition and returns the probability of each event exceeding this threshold for each day. The sum of these daily probabilities is combined to obtain the probability of at least one qualifying weather event occurring each day. The sum of these daily probabilities is the expected number of payout days for the forecast portion of the rental period.

We now continue with the prior example above regarding the forecast portion of the rental of March 29-April 2 to further explain the termination of daily probability and the determination of the expected number of payout days described in the preceding paragraph. A portion of the weather forecast information is shown as output of the API call below in Table 1, showing the probability of at least 0.5 inches of rain in the ten (10) hours following each hour at 123 Build St. (the “rental use location”). In this example shown in Table 1, the API probabilistic output indicates there is a 0.588% chance of 0.5 inches or more of rain in the 10 hours after 22:00 on March 23 (between March 23 22:00 and March 24 08:00). In this example, this output is filtered to the daily level by taking the hour at the beginning of the covered hours (6 AM) for each day (Table 2 shows a portion of the hourly probability rates, while Table 3 shows the filtered rates as determined for each day within the rental period utilizing the forecasted information (data), since the work day is intended to end at 4 PM (10 hours). Of course, different techniques may be used to determine the daily probability, such as selecting the highest probability during the work hours for each workday. Now, in summing the forecasted probabilities shown in Table 3, the expected number of payout days (that is, days where the concerned weather condition may exceed the threshold limit of 0.5 inches of rain) for the forecast portion is 0.07404 days (0.01479±0.01532±0.02891±0.004±0.01102=0.07404 days).

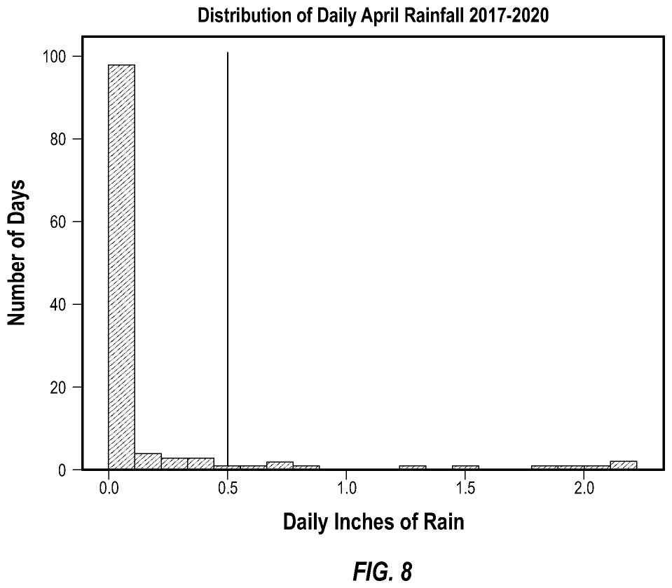

Now, with regard to the historic portion in this example, when specific daily forecasts can't be used or when its undesirable, historic observed data for the rental use location may be employed, such as may be obtained from IBM's conditions API or any other source. In the example data shown in Table 4, the previous 1-4 years of hourly weather is obtained for the corresponding months of the historic portion of the rental period (to account for seasonality). The number of years queried depends on the length of the historic portion of the rental period due to time constraints on the quote calculation process. For each day, the observed weather information (data) is used to determine if the coverage weather condition threshold was exceeded during the covered hours. Kernel density estimation is applied this data to estimate the probability distribution for all of the combined dependent coverage conditions. Random samples are drawn against the estimated probability distribution and the mean of all samples is taken to represent the probability of a payout (that is, the probability that the covered weather condition threshold will be met or exceeded). The daily probability of payout is combined with the length of the historic portion of the rental period to determine the expected number of payout days for the historic portion. With regard to the historic portion of April 5-April 9, the historical data obtained in this example only comprises the month of April, since the only month in this portion of the rental period concerns April. Accordingly, the API call will request the rainfall data at 123 Build St. (the rental use location) every day of the last 4 Aprils (2017-2020) during 6 AM and 4 PM (the daily work period). This data is shown in Tables 4A and 4B. The days highlighted in each of Tables 4A and 4B indicate the days on which it rained more than 0.5 inches at 123 Build St. Kernel density estimation is then performed using this data, which is represented in FIG. 8 by example. In this example, with regard to the probability distribution of rainfall on an April day, estimated using kernel density estimation using the data, the average probability of a random sample from this distribution is 0.1167. The average probability of 0.1167 is the estimate of the daily probability of a payout on every day of the historic portion of the rental period. Since there are 5 days in the historic portion, the expected number of payout days is 5*0.1167, or 0.5835 days. These same methods and techniques can be used more generally to determine probability and probability-based pricing or quotations.

Embodiments of these methods may further include determining, based upon the probability, a price to charge the renter to provide the renter a rental period extension should the observed weather condition during the rental period or during a time period preceding the rental period meet or exceed the covered weather condition parameter. This step is generally referred to as 110 in the exemplary method 100 shown in FIG. 1. With reference to FIG. 2, in another exemplary method 200, an alternative step of determining a price is shown as 210.

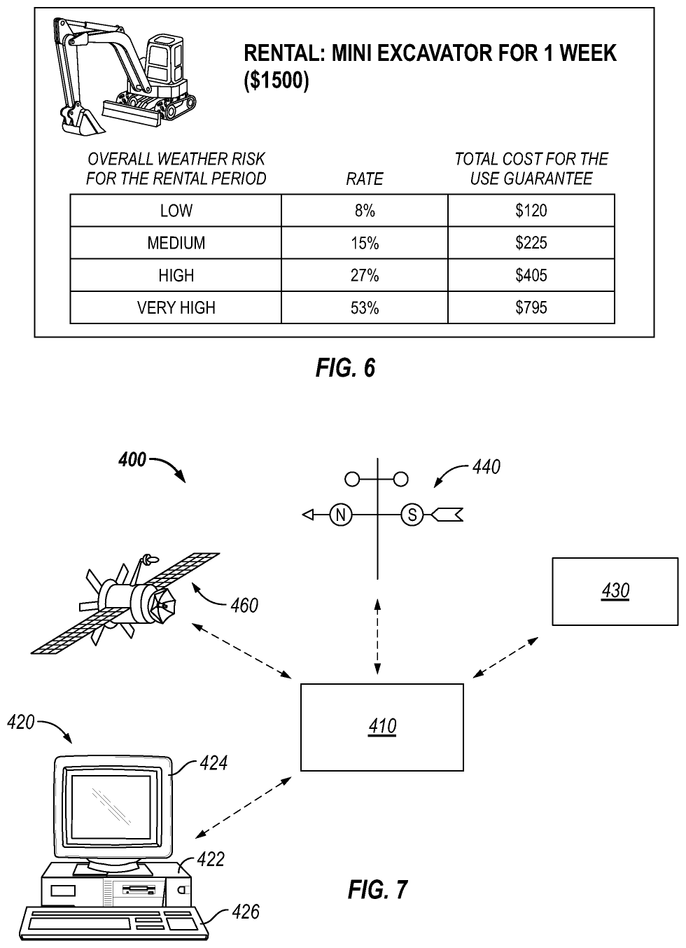

The more likely a covered weather condition parameter may be met during the rental period, the higher the price or price quotation for the use guarantee. This may be reflected in an hourly, daily, weekly, etc. price. The determination of a price or price quotation may be automated, taking into account the price charged by the rental source, where the determination is made, such as along a linear or non-linear scale, with 100% probability being the full price to rent the equipment as charged by the rental source. In other variations, pricing may be categorized in accordance with tiers of increasing probability, each tier being defined by a range of probabilities. As discussed with regard to the step of estimating in an exemplary embodiment shown in FIG. 5, the four (4) tiers of probability are shown in FIG. 6, in accordance with a particular exemplary embodiment, with the maximum probability for each tier (low, medium, high, and very high) together with the price quotation for each tier.

With reference to the working example provided above regarding the rental period of March 29-April 9, the pricing is determined as follows. The expected number of payout days in the forecast & historic portions are added together to determine the quote's total expected payout days. The final quote price is derived by combining the total expected payout days with the rental cost. In this example, the expected payout days from the forecast portion is 0.07404 days while the expected payout days from the historic portion is 0.5835 days. This makes the total expected payout days 0.07404+0.5835, or 0.6575 days. If, in this example, the total rental cost is $1,000 and covers 10 days, the daily cost is $100 ($1,000 divided by 10 days). Therefore, the expected cost is 0.6575*100, or $65.75. This plus an additional service charge or the like, whether percentage based or a fixed charge, becomes the final quote price that is returned to the renter. These same methods and techniques can be used more generally to determine probability-based pricing or quotations.

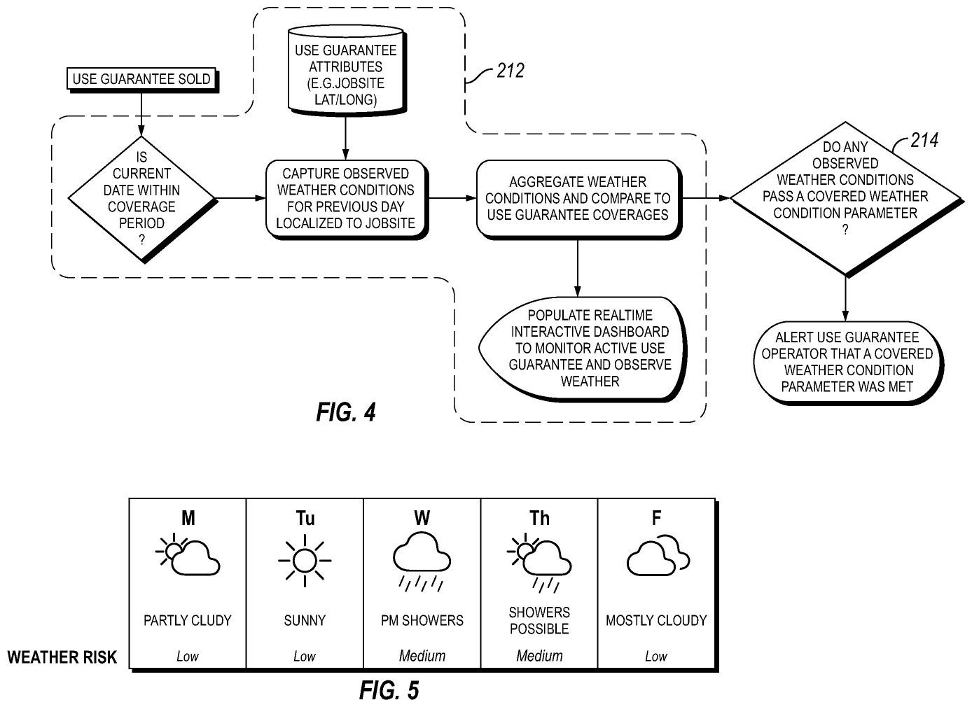

Embodiments of these methods may further include monitoring, by a processor of a computing device, observed weather condition information corresponding to the observed weather condition at or near the rental use location during the rental period or during a time period preceding the rental period. This step is generally referred to as 112 in the exemplary method 100 shown in FIG. 1. With reference to FIG. 4, an alternative step of monitoring is shown as 212 in accordance with a particular exemplary embodiment.

In an effort to cover a rental period and determine whether a cover weather condition has occurred, the weather is monitored. This may be accomplished by obtaining and analyzing actual weather conditions information. By doing so, weather condition information corresponding to or relating to the covered weather condition parameter is obtained.

The weather condition information is obtained during the rental period, and may optionally be obtained just prior to the beginning of the rental period. The weather condition information may be obtained at or near the rental location. For example, a weather station may be arranged at the rental location and weather condition information is obtained from such weather station. By further example, weather condition information may be obtained from a weather station located nearest the rental location, which may include any of a variety of sensors, such as for temperature, wind, and precipitation. In any event, observed weather condition information may be obtained from a sensor by way of a communication path. By further example, weather information may be obtained for the township or municipality in which the rental location is located.

The weather condition information may be obtained real-time or upon some permissible or desired delay at certain time intervals or pre-determined instances throughout the rental period or any time leading up to the rental period. This information may be stored on any computer readable storage medium operably coupled to a processor for performing the monitoring function.

Such methods may further include determining, by a processor of a computing device, if the observed weather condition meets or exceeds the covered weather condition parameter during the rental period or during a time period preceding the rental period at or near the rental use location. This step is generally referred to as 114 in the exemplary method 100 shown in FIG. 1. With reference to FIG. 4, an alternative step of determining is shown as 214 in accordance with a particular exemplary embodiment.

This is accomplished by comparing the observed weather condition information to the covered weather condition parameter. This comparison may be performed using one or more processors of any one or more computing devices. A notice acknowledging any such determination may be provided to the renter, rental source, and/or the guarantor, such as by email, text, or through any software product. It is contemplated any one or more of these actions may be performed automatically or otherwise.

Such methods may further include extending the rental period by an agreed duration if it is determined that the covered weather condition parameter was met or exceeded by the observed weather during the rental period or during a time period preceding the rental period at or near the rental use location.

This extension may occur automatically or otherwise. For example, a notice may be sent to the rental source and the renter that an extension is being provided, and the guarantor may be charged automatically or otherwise for such extension. It is appreciated that an extension may be provided based upon the occurrence of certain observed weather for the immediately following hour, day, etc. within the rental period, recognizing that based upon the current observed weather, the equipment may be not reasonably be usable for the next period (hour, day, etc.), such as when the premises needs to sufficiently dry or be cleaned due to the occurrence of an excessive amount of rain or other precipitation or due to the occurrence of a tornado or other excessive amount of wind and the ensuring damage created thereby.

It is appreciated that such methods may be performed on a computer system or device, or provided as a computer software product. As such, any and all methods and steps discussed and contemplated may be represented as instructions stored on one or more computer readable storage devices, and performed using one or more processors, all of which are in operable communication, such as by use of one or more communication paths.

In particular embodiments of such systems, a system comprises:
one or more processors; and,
one or more computer readable storage mediums in operable communication with the one or more processors, where the one or more computer readable storage mediums collectively including:
   obtaining instructions for obtaining equipment rental information stored on a non-transitory computer readable medium, the equipment rental information comprising information concerning a rental equipment item for rental by a rental party from a rental provider for a rental period at a rental use location, the equipment rental information including rental period information corresponding with the rental period, rental equipment item information corresponding to the rental equipment item, rental price information corresponding to the rental price for the rental equipment item, and the rental use location information corresponding to the rental use location;
   obtaining instructions for obtaining a covered weather condition parameter stored on a non-transitory computer readable medium, the covered weather condition parameter corresponding to a weather condition that may occur during the rental period or during a time period preceding the rental period at the rental use location, the covered weather condition parameter being a threshold amount of the weather condition that would trigger a use guarantee for the rental equipment item during the rental period or during a time period preceding the rental period;
   receiving instructions for receiving, via a network interface, predictive weather condition information corresponding to the weather condition that may occur during the rental period or during a time period preceding the rental period at the rental location;
   estimating instructions for estimating, by a processor of a computing device, a probability of an occurrence that the weather condition, as an observed weather condition, will result in meeting or exceeding the covered weather condition parameter during the rental period or during a time period preceding the rental period at the rental use location;
   determining instructions for determining, based upon the probability, a price to charge the renter to provide the renter a rental period extension should the observed weather condition during the rental period or during a time period preceding the rental period meet or exceed the covered weather condition parameter;
   monitoring instructions for monitoring, by a processor of a computing device, observed weather condition information corresponding to the observed weather condition at or near the rental use location during the rental period or during a time period preceding the rental period; and,
   determining instructions for determining, by a processor of a computing device, if the observed weather condition meets or exceeds the covered weather condition parameter during the rental period or during a time period preceding the rental period at or near the rental use location.

With reference to an exemplary embodiment shown in FIG. 7, a system 400 includes a computing system 410 comprising one or more computer readable storage mediums and one or more processors, all of which may be local to one another or any of which may be remote to another. Computing system 410 includes the instructions for performing the methods described herein, although it is contemplated that certain instructions maybe included on other devices described herein. Computing device 410 is in communication via a communication path with a remote computing device 420 of the rental provider. Rental provider computing device 420 includes a processor 422 in communication with an output device 424 via a communication path, the output device 424 being a graphical use interface. Processor 422 is also in communication with an input device 426 via a communication path. Computing device 410 obtains rental equipment information from rental provider computing device, or a remote computer readable storage medium employed by rental provider to store rental equipment information. Additionally, or in the alternative, rental equipment information may be obtained from other sources, such as the renting party and any computer readable storage medium employed by the renting party. As further provided herein, other sources of rental equipment information are contemplated. Additional equipment rental information, such as information (data) concerning the rental use location, weather forecasts, and observed weather, may be obtained from other sources, such as databases or other data files stored on any computer readable storage medium 430, weather stations or weather measuring sensors 440, and satellites 460 via corresponding communication paths.

Certain exemplary embodiments of the computer program provide a computer program product including instructions embodied on one or more computer readable storage mediums, the instructions comprising:
obtaining instructions for obtaining equipment rental information stored on a non-transitory computer readable storage medium, the equipment rental information comprising information concerning a rental equipment item for rental by a rental party from a rental provider for a rental period at a rental use location, the equipment rental information including rental period information corresponding with the rental period, rental equipment item information corresponding to the rental equipment item, rental price information corresponding to the rental price for the rental equipment item, and the rental use location information corresponding to the rental use location;
obtaining instructions for obtaining a covered weather condition parameter stored on a non-transitory computer readable medium, the covered weather condition parameter corresponding to a weather condition that may occur during the rental period or during a time period preceding the rental period at the rental use location, the covered weather condition parameter being a threshold amount of the weather condition that would trigger a use guarantee for the rental equipment item during the rental period or during a time period preceding the rental period;
receiving instructions for receiving, via a network interface, predictive weather condition information corresponding to the weather condition that may occur during the rental period or during a time period preceding the rental period at the rental location;
estimating instructions for estimating, by a processor of a computing device, a probability of an occurrence that the weather condition, as an observed weather condition, will result in meeting or exceeding the covered weather condition parameter during the rental period or during a time period preceding the rental period at the rental use location;
determining instructions for determining, based upon the probability, a price to charge the renter to provide the renter a rental period extension should the observed weather condition during the rental period or during a time period preceding the rental period meet or exceed the covered weather condition parameter;
monitoring instructions for monitoring, by a processor of a computing device, observed weather condition information corresponding to the observed weather condition at or near the rental use location during the rental period or during a time period preceding the rental period; and,
determining instructions for determining, by a processor of a computing device, if the observed weather condition meets or exceeds the covered weather condition parameter during the rental period or during a time period preceding the rental period at or near the rental use location.

To the extent used, the terms “comprising,” “including,” and “having,” or any variation thereof, as used in the claims and/or specification herein, shall be considered as indicating an open group that may include other elements not specified. The terms “a,” “an,” and the singular forms of words shall be taken to include the plural form of the same words, such that the terms mean that one or more of something is provided. The terms “at least one” and “one or more” are used interchangeably. The term “single” shall be used to indicate that one and only one of something is intended. Similarly, other specific integer values, such as “two,” are used when a specific number of things is intended. The terms “preferably,” “preferred,” “prefer,” “optionally,” “may,” and similar terms are used to indicate that an item, condition or step being referred to is an optional (i.e., not required) feature of the embodiments. Ranges that are described as being “between a and b” are inclusive of the values for “a” and “b” unless otherwise specified.

While various improvements have been described herein with reference to particular embodiments thereof, it shall be understood that such description is by way of illustration only and should not be construed as limiting the scope of any claimed invention. Accordingly, the scope and content of any claimed invention is to be defined only by the terms of the following claims, in the present form or as amended during prosecution or pursued in any continuation application. Furthermore, it is understood that the features of any specific embodiment discussed herein may be combined with one or more features of any one or more embodiments otherwise discussed or contemplated herein unless otherwise stated.

I/We claim:

1. A method of providing an equipment use guarantee quotation comprising:
obtaining equipment rental information stored on a non-transitory computer readable medium, the equipment rental information comprising information concerning a rental equipment item for rental by a rental party from a rental provider for a rental period at a rental use location, the equipment rental information including rental period information corresponding with the rental period, rental equipment item information corresponding to the rental equipment item, rental price information corresponding to the rental price for the rental equipment item, and the rental use location information corresponding to the rental use location;
obtaining a covered weather condition parameter stored on a non-transitory computer readable medium, the covered weather condition parameter corresponding to a weather condition that may occur during the rental period or during a time period preceding the rental period at the rental use location, the covered weather condition parameter being a threshold amount of the weather condition that would trigger a use guarantee for the rental equipment item during the rental period or during a time period preceding the rental period;
receiving, via a network interface, predictive weather condition information corresponding to the weather condition that may occur during the rental period or during a time period preceding the rental period at the rental location;
estimating, by a processor of a computing device, a probability of an occurrence that the weather condition, as an observed weather condition, will result in meeting or exceeding the covered weather condition parameter during the rental period or during a time period preceding the rental period at the rental use location;
determining, based upon the probability, a price to charge the renter to provide the renter a rental period extension should the observed weather condition during the rental period or during a time period preceding the rental period meet or exceed the covered weather condition parameter;
monitoring, by a processor of a computing device, observed weather condition information corresponding to the observed weather condition at or near the rental use location during the rental period or during a time period preceding the rental period; and,
determining, by a processor of a computing device, if the observed weather condition meets or exceeds the covered weather condition parameter during the rental period or during a time period preceding the rental period at or near the rental use location.

2. The method of claim 1 further comprising:
extending the rental period by an agreed duration if it is determined that the covered weather condition parameter was met or exceeded by the observed weather during the rental period at or near the rental use location.

3. The method of claim 1, where the covered weather condition parameter is a minimum threshold amount of precipitation.

4. The method of claim 1, where the rental period information includes a daily working period for the renter during the rental period.

5. The method of claim 1, where the time period preceding the rental period is a day.

6. The method of claim 1, where the weather event is an ambient outside air temperature exceeding a minimum threshold temperature.

7. The method of claim 1, where the weather event is an ambient outside air temperature extending below a minimum threshold temperature.

8. The method of claim 1, where the equipment rental information is obtained from a remote source by way of a communication path.

9. The method of claim 1, where the observed weather condition information is obtained from a remote source by way of a communication path.

10. The method of claim 1, where in estimating the probability, if the rental period is within a near-term defined period prior to the rental period, a current weather forecast for the rental period is obtained and employed.

11. The method of claim 11, where in estimating the probability, prior historical weather forecasts are compared to observed weather conditions to determine a probability distribution of error associated with the current weather forecast, where the probability distribution of error is used to better determine the probability using the current weather forecast.

12. The method of claim 1, where in estimating the probability, historical observed weather information for the rental period is employed.

13. The method of claim 12, where in estimating the probability, more recent historical observed weather information is more heavily weighted than older historical observed weather information.

14. The method of claim 13, where in estimating the probability, a particular quantity of the most recent years of historical weather information is obtained and certain periods are selected and a probability distribution is generated to determine the probability.

15. The method of claim 1, where in estimating the probability, probability density estimation is performed using the historical observed weather information.

16. The method of claim 1, where the agreed duration is a calendar day for every day during the rental period upon which the weather event occurs.

17. The method of claim 1 further comprising:
paying a renter provider or a renter to extend the rental period.

18. A computer program product including instructions embodied one or more computer readable storage mediums, the instructions comprising:
obtaining instructions for obtaining equipment rental information stored on a non-transitory computer readable medium, the equipment rental information comprising information concerning a rental equipment item for rental by a rental party from a rental provider for a rental period at a rental use location, the equipment rental information including rental period information corresponding with the rental period, rental equipment item information corresponding to the rental equipment item, rental price information corresponding to the rental price for the rental equipment item, and the rental use location information corresponding to the rental use location;
obtaining instructions for obtaining a covered weather condition parameter stored on a non-transitory computer readable medium, the covered weather condition parameter corresponding to a weather condition that may occur during the rental period or during a time period preceding the rental period at the rental use location, the covered weather condition parameter being a threshold amount of the weather condition that would trigger a use guarantee for the rental equipment item during the rental period or during a time period preceding the rental period;
receiving instructions for receiving, via a network interface, predictive weather condition information corresponding to the weather condition that may occur during the rental period or during a time period preceding the rental period at the rental location;
estimating instructions for estimating, by a processor of a computing device, a probability of an occurrence that the weather condition, as an observed weather condition, will result in meeting or exceeding the covered weather condition parameter during the rental period or during a time period preceding the rental period at the rental use location;
determining instructions for determining, based upon the probability, a price to charge the renter to provide the renter a rental period extension should the observed weather condition during the rental period or during a time period preceding the rental period meet or exceed the covered weather condition parameter;
monitoring instructions for monitoring, by a processor of a computing device, observed weather condition information corresponding to the observed weather condition at or near the rental use location during the rental period or during a time period preceding the rental period; and,
determining instructions for determining, by a processor of a computing device, if the observed weather condition meets or exceeds the covered weather condition parameter during the rental period or during a time period preceding the rental period at or near the rental use location.

19. A method of determining the likelihood of an occurrence of a covered weather condition parameter associated with a particular weather event, the method comprising:
obtaining equipment rental information stored on a non-transitory computer readable medium, the equipment rental information comprising information concerning a rental equipment item for rental by a rental party from a rental provider for a rental period at a rental use location, the equipment rental information including rental period information corresponding with the rental period, rental equipment item information corresponding to the rental equipment item, rental price information corresponding to the rental price for the rental equipment item, and the rental use location information corresponding to the rental use location;
obtaining a covered weather condition parameter stored on a non-transitory computer readable medium, the covered weather condition parameter corresponding to a weather condition that may occur during the rental period or during a time period preceding the rental period at the rental use location, the covered weather condition parameter being a threshold amount of the weather condition that would trigger a use guarantee for the rental equipment item during the rental period or during a time period preceding the rental period;
receiving, via a network interface, predictive weather condition information corresponding to the weather condition that may occur during the rental period or during a time period preceding the rental period at the rental location; and,
estimating, by a processor of a computing device, a probability of an occurrence that the weather condition, as an observed weather condition, will result in meeting or exceeding the covered weather condition parameter during the rental period or during a time period preceding the rental period at the rental use location.
